(19) United States
(12) Patent Application Publication
(10) Pub. No.: US 2005/0021349 A1
(43) Pub. Date: Jan. 27, 2005

(54) Method and system for providing a computing resource service

(75) Inventors: Georgios Cheliotis, Zurich (CH); Christopher M. Kenyon, Zurich (CH)

Correspondence Address: SCULLY SCOTT MURPHY & PRESSER, PC, 400 GARDEN CITY PLAZA, GARDEN CITY, NY, 11530, US

(73) Assignee: INTERNATIONAL BUSINESS MACHINES CORPORATION, ARMONK, NY (US)

(21) Appl. No.: 10/625,177

(22) Filed: Jul. 23, 2003

(51) Int. Cl. G06F 17/60

(52) U.S. Cl. 705/1

(57) ABSTRACT

A system and method for providing a requested computing service, wherein a contract describes conditions of the requested computing service, wherein a contract guarantor accepts the contract and guarantees to provide the requested computing service with the given conditions, wherein the guarantor uses a second computing resource and a first computing resource for fulfilling the contract, wherein the second computing resource provides computing capacity according to a stochastic process that is not controlled by the guarantor wherein the first computing resource is controlled by the guarantor to provide a requested computing service, whereby the guarantor uses the second computing resource for fulfilling the contract and uses the first computing resource for guaranteeing the fulfillment of the contract, if the contract could not be fulfilled using solely the second computing resource.

### BACKGROUND OF THE INVENTION

1. Field of the Invention

The present invention relates to the establishment of grid computing and particularly, relates to a method and a system for providing a requested computing service.

2. Description of the Prior Art

Business models in grid computing around buying and selling resources across budget boundaries within or between organizations are in their very early stages. Cycle-harvesting or cycle-scavenging or cycle-stealing is a significant area of grid and cluster computing with software available from several vendors. However, creating commercial contracts based on resources made available by cycle-harvesting is a significant challenge for two reasons. Firstly, the characteristics of the harvested resources are inherently stochastic. Secondly, in a commercial environment, purchasers can expect the sellers of such contracts to optimize versus the quality of service definitions provided.

These challenges have been successfully met in conventional commodities, for example random length lumber, traded in financial exchanges, for example the Chicago Mercantile Exchange. The essential point for creating a commercially valuable quality of service (QoS) definition is to guarantee a set of statistical parameters of each and every contract instance.

The main problem of cycle-scavenging in a commercial environment where resources are traded, is the current impossibility to provide a guarantee on the quality of service (QoS) that will be provided by such a system. This is a problem because users can expect providers to optimize against their guarantees. When these guarantees are poor, the value is correspondingly low.

In the state of the art different solutions are known that provide an improved method for scheduling jobs on a computing system, i.e.: A. Rosenberg. Optimal schedules for cycle-stealing in a network of workstations with a bag-of-tasks workload. IEEE Transactions on Parallel and Distributed Systems, 13(2):179-191, February 2002; E. Heymann, M. Senar, E. Luque, and M. Livny. Evaluation of strategies to reduce the impact of machine reclaim in cycle-stealing environments. IEEE 1st International Symposium on Cluster Computing and the Grid, May 2001. pp. 320-328; K. Ryu and J. Hollingsworth. Exploiting fine grained idle periods in networks of workstations. IEEE Transactions on Parallel and Distributed Systems, 11(7):683-699, 2000; A. Rosenberg. Guidelines for data-parallel cycle-stealing in networks of workstations, ii: On maximizing guaranteed output. IEEE 10th Symposium on Parallel and Distributed Processing, April 1999. pp 520-524; and, S. Leutenegger and X.-H. Sun. Limitations of cycle stealing for parallel processing on a network of homogeneous workstations. Journal of Parallel and Distributed Computing, 43:169-178, 1997.

The current state of the art addresses the creation of a guaranteed quality of service at the resource level by concentrating on job scheduling, not resource management. It is thus desired to change the delivered quality of a resource service and not to provide guarantees on jobs.

It would be highly desirable to provide a system and method for providing a requested computing service and a system for providing a requested computing service that guarantees the quality of the computing service.

### SUMMARY OF THE INVENTION

It is an object of the present invention to provide a system and method for providing a requested computing service and a system for providing a requested computing service that guarantees the quality of the computing service.

According to the preferred embodiment of the invention, there is provided a complete system and methodology for providing a requested computing service using a stochastic computing resource and a deterministic computing resource. The combination of the deterministic and the stochastic computing resource has the advantage that unused computing capacity of the stochastic resource is used for providing a requested computing service and furthermore, the deterministic resource is used for guaranteeing the quality of the requested computing resource. Therefore, the less valuable computing capacity of the stochastic resource could be sold for a higher price because of the guaranteeing of the quality of service carried out by the deterministic computing resource. In addition the cost of doing so is lower than using deterministic resources exclusively.

In a preferred embodiment of the invention, a guarantor accepts a contract for providing a computing service with determined conditions, whereby the guarantor primarily uses the stochastic computing resource for providing the requested computing service and secondly uses, if it is not possible to fulfill the contract solely with the stochastic computing resource, the deterministic computing resource for guaranteeing the fulfilling of the contract.

Before accepting a contract, the guarantor checks whether it is possible to provide the quality of the computing service that is defined by the contract. The guarantor compares the conditions of the contracts and checks whether it is possible to fulfill the conditions of the contract using the deterministic and stochastic computing resources. If it is possible, the guarantor accepts the contracts but primarily uses the stochastic computing resource for providing the requested quality of the computing service under the conditions of the contract. It is advantageous to use the stochastic computing resource as much as possible since the computing capacity of the stochastic computing resource is worth less than the computing capacity of the deterministic computing resource. Therefore, it is advantageous for the guarantor to use the stochastic computing resource as much as possible for fulfilling the contract under the predetermined conditions.

The guarantor also has the possibility of accepting contracts when there is only a given probability of fulfilling the conditions of the contracts. However the guarantor can calculate this probability. Thus the guarantor can choose the level of quality to provide. Else, the guarantor would have only two qualities available: the one provided by deterministic resources—certainty at a high cost; and the one provided by stochastic resources—an unknown degree of uncertainty at a low cost.

The stochastic computing resource is preferably constituted as a grid computing network with computing machines that compute their own tasks and provide computing capacity during idling states to the guarantor for fulfilling requested computing capacity according to a contract.

In particular, the invention provides the ability to guarantee the parameters of a statistical quality of service, which is termed “hard statistical quality of service” or HSQ. A statistical quality of service is one where the parameters of the service are based on statistical measurements of service metrics, for example the quantiles of the lengths of a set of slots. A slot is an uninterrupted period available for computation on a resource.

In a preferred embodiment of the invention, the state of fulfillment of the conditions of the contract are changing wherein the conditions are monitored by the guarantor. The guarantor uses the stochastic and the deterministic computing resource according to the changing state of fulfillment of the conditions of the contract in order to fulfill the contract.

The proposed system comprises, for providing a requested computing service, a general controller, a stochastic computing resource, a deterministic computing resource, a first monitor that monitors the capacity of the deterministic computing resource for the general controller, a second monitor that monitors the capacity of the statistic computing resource for the general controller, a controller unit that controls the computing capacity of the deterministic computing resource for the general controller, a handling unit that is used by the general controller to use the provided computing capacity of the stochastic computing resource whereby the general controller primarily uses the stochastic computing resource for fulfilling a contract under given conditions, whereby the general controller secondly controls the deterministic computing resource in order to guarantee the fulfillment of the contract if this is not possible by merely using the stochastic computing resource. The system has the advantage that the computing capacity of a statistic computing resource that has low value could be used for at least partly fulfilling a contract for providing a requested computing service with guarantee, whereby the deterministic computing resource is controlled for guaranteeing the fulfillment of the contract.

### BRIEF DESCRIPTION OF THE DRAWINGS

The objects, features and advantages of the present invention will become apparent to one skilled in the art, in view of the following detailed description taken in combination with the attached drawings, in which:

FIG. 1 depicts a schematic view of a system for providing a requested computing service using a stochastic and a deterministic computing resource according to the invention;

FIG. 2 is a flow-chart depicting an example for accepting and fulfilling a contract for providing a requested computing resource according to the invention;

FIG. 3 is a flow-chart depicting a method of fulfilling a contract according to the invention; and,

FIG. 4 is a flow-chart depicting a method of fulfilling a group of contracts according to the invention.

### DETAILED DESCRIPTION OF THE PREFERRED EMBODIMENTS

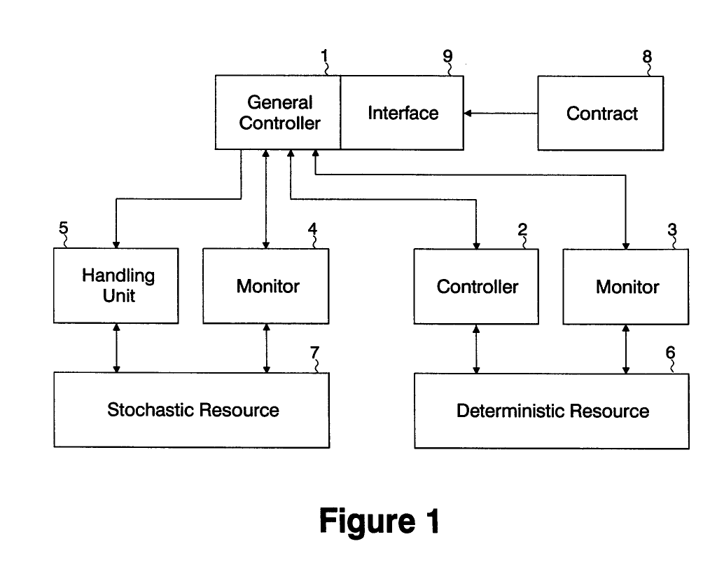

FIG. 1 is a schematic view depicting a system for providing a requested computing service with a defined level of quality according to a contract. The system comprises a general controller unit 1 that is connected to a first controller unit 2, a first monitoring unit 3, a second monitoring unit 4 and a handling unit 5. The general controller unit 1 comprises an interface 9 being connected to a computing unit 8 for accepting a contract and for providing a computer service. The first controller unit 2 and the first monitoring unit 3 are connected to the deterministic computing resource 6. The deterministic computing resource 6 is a network or a computer system or a computing machine that is controlled by the first controller unit 2 using the general controller 1. This means that the general controller unit 1 may decide how to use the computing capacity of the deterministic computing resource 6.

The second monitoring unit 4 and the handling unit 5 are connected to a stochastic computing resource 7. The stochastic computing resource 7 may be a computing network or a computing engine that provides, for example during idle times in which the stochastic computing resource does not need its computing capacity for working on own jobs, the free computing capacity to the general controller unit 1. The general controller unit 1 can use the provided computing capacity of the stochastic computing resource 7 for fulfilling an accepted contract. The stochastic computing resource 7 may be a computer capacity harvesting system within a grid of computers that harvest free computing capacities of the computers and provide the diverted computing capacity to the general controller unit 1. The handling unit 5 may have the ability to stop work it has started on the stochastic resource but it does not have the ability to stop work that it has not started. Thus, the handling unit 5 has negative control over work that it has started. The handling unit 5 does not have positive control over the stochastic resource 7, unlike the first controller unit 2 with the deterministic resource 6.

The stochastic computing resource 7 stochastically provides a computing service without positive control from outside. Positive control would mean that the general controller unit could guarantee that the stochastic computing resource would provide computing capacity. For example the general controller unit 1 cannot guarantee that a given amount of computing time will be available on a stochastic resource 7 before a given deadline. On the other hand the general controller unit 1 may be able to control an interruption or cessation of a task or program on the stochastic resource 7 for fulfilling a contract. For example if a program, started by the general controller unit is running on the stochastic computing resource it may be possible for the general controller unit to stop that program. Thus even for stochastic resources an outside controller may have negative control but not positive control. The deterministic computing resource is controlled by the general controller unit 1 and provides computing service upon request in the sense of positive and negative control.

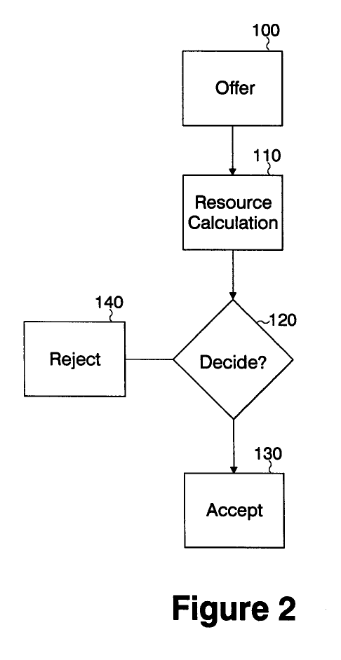

FIG. 2 illustrates a flow-diagram of an example procedure for offering and accepting a contract according to the invention. At a program point 100, a computing unit 8 is connected by the interface with the general controller unit 1 and offers a contract for delivering with predetermined conditions a computing service. The predetermined conditions may include one or more of, but are not limited to: the costs for the computing service, the possibility of fulfilling contract, the quality of the computing service which means for example an average number of operations or cycles over a given duration, an average length of a slot for computing where all the computing power of a machine is available, the number of slots, a deadline until which the contract has to be fulfilled, and so on.

The conditions of the contract may, for example, include but are not limited to, one or more of: the costs for providing the computing service, the possibility of fulfilling the contract, the quality of the computing service, a number of slots of computing capacity, an average length of a slot, a specification of the distribution of the lengths of the slots, a specification of the distribution of the work to be carried out in the computing service instances, a deadline for fulfilling the contract.

A contract typically includes a set of instances of a computing service. These instances may be defined relative to the length of a computing slot, a given amount of computation that may be interrupted or done at varying rates, a given amount of computation that may not be interrupted and that must be done at least at some given rate. The conditions of the contract may for example be functions of the definitions of instances of the computing services for example the average length of a computing slot.

At the following program point 110, the general controller unit 1 checks whether it is possible using the deterministic resource 6 to fulfill the contract. The general controller unit 1 monitors by means of the first monitoring unit 3 which computing capacity could be guaranteed by the deterministic computing resource 6. For the stochastic computing resource 7, statistical probabilities for providing computing capacity by the stochastic computing resource 7 are calculated. For the deterministic computing resource 6, sure values for the computing capacity that could be assuredly provided by the deterministic computing resource 6 are determined. The values may comprise, for example, the number of slots that could be provided within a predetermined time and the length of the slots within the predetermined time. The statistical probabilities may comprise the average number of slots within the predetermined time and the average length of slots within the predetermined time that may be provided under usual conditions by the stochastic resource 7. In contrast to the sure values of the deterministic computing resource 6, the statistical probabilities of the stochastic computing resource 7 cannot be guaranteed, but under normal conditions they could be provided by the stochastic computing resource 7 to the general controller unit 1 for fulfilling the contract.

At the next program point 120 shown in FIG. 2, the general controller unit 1 decides whether the proposed contract could be assuredly fulfilled. The proposed contract may be assuredly fulfilled if the computing capacity of the deterministic computing resource 6 is enough for fulfilling the contract within the given conditions. In another embodiment of the invention, the general controller unit 1 may additionally consider the stochastic computing resource capacity in addition to the deterministic computing resource capacity in order to decide whether the contract could be fulfilled within the predetermined conditions and with a probability acceptable to the general controller unit 1 that is specified by the owner of the computing service provider.

If it is decided at program point 120 that the contract could be fulfilled by the general controller unit 1 with an acceptable probability, the general controller unit 1 accepts the contract at the following point 130. If it is decided at program point 120 that the general controller unit 1 can not momentarily fulfill the contract with an acceptable probability, then the contract is rejected at the following point 140 shown in FIG. 2.

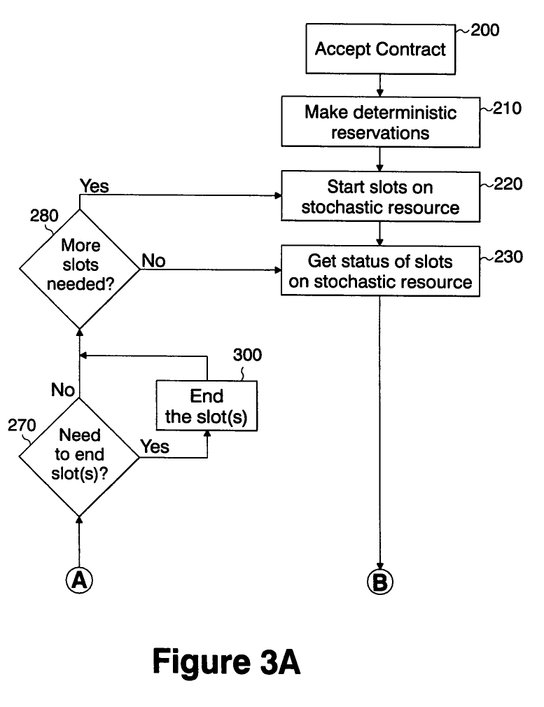

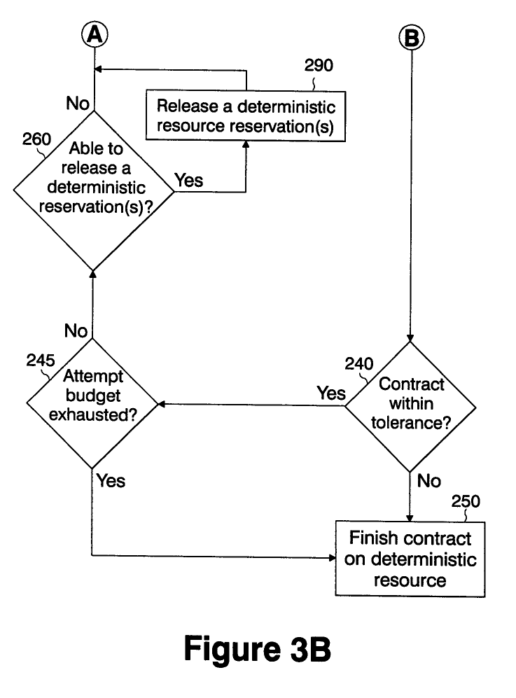

FIG. 3 describes in a flow diagram the process that the system uses for fulfilling a contract with the deterministic computing resource 6 and the stochastic computing resource 7.

Considering an example of the invention where the conditions of the contract are specified relative to the service instances and a provider of computing capacity desires to guarantee the conditions with certainty. Firstly, the contract is only accepted providing that there are sufficient resources available on the deterministic resources 6 of the provider to carry out the contract. When the contract is accepted deterministic resources 6 are reserved sufficient to satisfy the conditions of the contract. The reservations are made in such a way as to permit the maximum possible use of the stochastic resources 7 for fulfilling the contract. The provider, using the general controller unit 1, tries to fulfill the contract using computing capacity on the stochastic resources 7. During the contract fulfillment, the conditions of the contract yet to be fulfilled are continuously monitored. As the conditions are gradually fulfilled the reserved computing capacity of the deterministic resources 6 that are no longer needed to guarantee the contract's fulfillment with certainty are released. In addition, as the conditions of the contract are gradually fulfilled new reservations of computing capacity on the deterministic resources 6 are made and previous reservations of computing capacity of the deterministic resources 6 are released so as to. permit the maximum possible exploitation of the stochastic resources and to save computing capacity of the deterministic resource 6. This is done, however, always respecting the constraint that the contract may be fulfilled with certainty or with a determined probability.

During the contract, if the conditions achieve or exceed a tolerance level of being violated, the remainder of the contract, that means the computing capacity that still has to be provided for fulfilling the contract is transferred to the deterministic computing resource 6 and provided by the deterministic computing resource. Therefore, the fulfillment of the contract as guaranteed by the provider as the guarantor is assured with certainty.

Referring to FIG. 3, at program point 200, the general controller unit 1 accepts a contract with given conditions. In this example, the conditions are that n, e.g., ten (10), time slots each with a fixed uninterrupted length of computing on a given machine type and configuration of one hour will be provided before an end time T_{end}.

The general controller unit 1 reserves at the step 210 sufficient computing capacity on the deterministic computing resource 6 that is necessary for fulfilling the contract. The reservations are made in such a way as to permit the maximum possible use of the stochastic computing resource 7. In this example, this condition could be fulfilled by reserving one hour on each of ten deterministic machines fulfilling the type and configuration requirements starting at T_{end}−1 where we assume in this example that these reservations are available. The process flow then continues to step 220. In this example, supposing that the system has been set with a tolerance level of two minutes, if the contract is within one minute of not being fulfilled then the contract will be transferred to the deterministic resource.

At step 220, the general controller unit 1 commences by initiating up to n slots of computing time on the stochastic resource 7. The process flow then continues to step 230 at which point the general controller 1 obtains the status of the slots on the stochastic resource that were started at program point 220. For this example, it is assumed that only six slots were started at program point 220 and at program point 230, it is determined that two of those slots have been terminated on the stochastic resource because native programs required the resources that they had been started on. Native programs are those that usually run on the stochastic resources and which have complete control of these resources as they are started by the owners of the stochastic resources. Thus, in this example, at step 230, only four slots are still running. In this example, it is further assumed that steps 230 and 240 are reached and exited at least every two minutes, the system tolerance level. The process flow thus continues to step 240.

At program point 240, the contract is evaluated as to whether it is still within the tolerance level of the system. In this example the tolerance level is two minutes. Thus in this case if (T_{end}−1 minute) is still more than two minutes away the contract is within tolerance. The quantity of the tolerance is calculated for guaranteeing enough computing capacity on the deterministic resource for fulfilling the contract. If the contract is not within tolerance, then all remaining parts of the contract that have not been fulfilled are immediately transferred to the deterministic resource 6, as indicated at step 250, where reservations have been made, and the contract is fulfilled. If the contract is within tolerance then process flow continues to step 245, where the contract status is evaluated to see whether all allowed attempts to use stochastic resources have been exhausted. At the beginning of the contract fulfillment process, the general controller gives the contract a budget of a number of allowed attempts to use stochastic resources 7. In one embodiment of the invention, this number of attempts is equal to the number of slots specified in the contract. In another embodiment this can be a function of the number of specified slots, for example twice the number. If the allowed attempts to use stochastic resources 7 have been exhausted, then the process flow continues at step 250 and the contract is finished on the deterministic resource 6. If the number of allowed attempts has not been exhausted then the process flow move to program point 260.

In FIG. 3, at program point 260 the general controller 1 examines the fulfillment status of the contract to determine whether any deterministic reservations 6 can be released. If a reservation can be released, process flow moves to program point 290, where any unneeded reservations are released. In this example, each time a slot (e.g., of 1 hour) is accomplished on the stochastic resource 7 a reservation for such a slot on the deterministic resource 6 can be released. If it is determined that no deterministic reservations 6 can be released, or otherwise, after releasing deterministic reservations, process flow continues to program point 270 where the general controller 1 examines the fulfillment status of the contract to determine whether any slots should be ended. If a slot should be ended, process flow moves to program point 300, otherwise process flow moves to program point 280.

At program point 300, slots that should end are ended. After this is performed, process flow move to program point 280 where the general controller 1 examines the fulfillment status of the contract to determine whether any more slots should be started on the stochastic resource. In the example, if there are less than n slots either currently running or accomplished then more slots should be started. If more slots should be started, process flow returns to step 220, otherwise process flow continues to step 230.

It should be understood that steps 280, and 270 with 300 conditionally, and 260 with 290 conditionally may be performed in any order. Further, it is understood that this algorithm starts with at most n slots.

It should be further understood that the conditions of the contract may vary. Thus, in another example for a contract, the conditions of the contract are a set of n time slots with an average of the time available of at least m hours, whereby the contract has to be fulfilled before a deadline T_{end}. Zero-length slots are permitted. This contract could also be handled according to the procedures of FIG. 2 and FIG. 3.

In another example of a contract the conditions of the contract are the set of n time slots with a specification of the quantiles of the distribution of delivered lengths. For example, there may be four quantiles with specified minimum and maximum lengths for each quantile.

The conditions of the contracts may vary and define the costs, the possibility of fulfilling the contract, the quality, the computing service, the cycle times, the number of slots available, an average time of a slot, or other constraints that are of importance for the contract.

In another scenario, the guarantor wishes to guarantee the conditions of contracts a probability P that the guarantor chooses and where the guarantor is guaranteeing a number n of contracts. The following description provides an inductive procedure that the guarantor can follow to ensure that the contracts are guaranteed to the given probability P that the guarantor can choose. Clearly as the probability P approaches unity, the degree of assurance of carrying out the conditions of the contracts approaches certainty. Additionally certainty, P=1, can be chosen by the guarantor.

In this case, the guarantor calculates the probability distribution of the required amount of deterministic resources 6 required to fulfill all the currently accepted contracts. The guarantor reserves deterministic resources 6 according to this probability distribution using the percentile P that corresponds to the degree of certainty that the contract guarantor wishes to maintain with respect to the set of accepted contracts. When considering whether to accept a new contract the guarantor first recalculates the probability distribution of required resources and locates the appropriate percentile P. If there are sufficient deterministic resources 6 available the contract is accepted, otherwise it is rejected. During the duration of each contract, if the conditions for a contract approach or exceed a tolerance level of being violated then the remainder of the contract is transferred to the deterministic computing resource 6 and carried out using the deterministic computing resource 6. Given that the amount of deterministic resources 6 reserved is used jointly for all the accepted contracts, and there are not enough deterministic resources reserved for each contract separately, and that the total quantity of reserved resources is only sufficient with probability P, there will be occasions when this transfer is impossible. In these cases the contract conditions will be violated. However, the guarantor will maintain the required percentage P of contracts carried out respecting the contract conditions.

Additionally, the general controller may be designed so that the percentage of contracts that fail are chosen so that these cause the minimum cost in terms of penalties or other conditions such as specifying that the percentage P should hold independently for given subgroups of contracts, for example contracts of similar size, in terms of resources or value, may be grouped together.

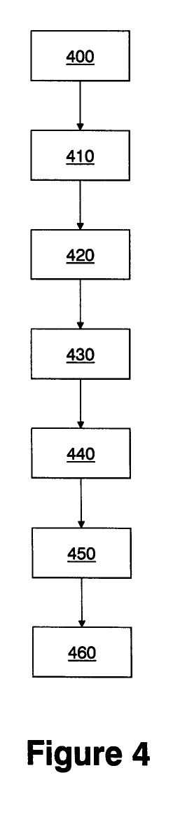

FIG. 4 shows a further embodiment of the inventive procedure. At a program point 400, the general controller unit 1 accepts a number n of contracts with given conditions guaranteeing to fulfill all the contracts. At the following step 410, the general controller unit 1 determines a given probability P by means of which the fulfillment of the contracts is guaranteed. The chosen probability may vary between 0 and 1. At the following step 420, the general controller unit 1 calculates a probability distribution of the required amount of computing capacity of the deterministic resource for fulfilling the sum of accepted contracts. The general controller unit 1 reserves as much computing capacity on the deterministic resource according to the calculated probability distribution using the percentage that corresponds to the degree of certainty that the contract guarantor wishes to maintain with respect to the set of accepted contracts. At the following step 430, the general controller unit 1 determines whether there is an offer for a new contract. Before accepting the new offer for a contract, the general controller unit 1 recalculates the probability distribution of the required computing capacity on the deterministic resources and determines the appropriate percentage of the available computer capacity on the deterministic resource 6 for fulfilling the new contract. If there is sufficient computer capacity on the deterministic resources 6, the general controller unit 1 accepts the new contract. Otherwise, the general controller unit 1 rejects the new offer. At the following step 440, the general controller unit 1 monitors for each contract during the fulfilling of the contract, if the conditions of the contract lie within a tolerance level of being violated. If this is the case, the general controller unit 1 transfers the remainder of the contract to the deterministic computing resource. The remainder of the contract is completed by the deterministic computing resource 6. At the following program step 450, the general controller unit 1 terminates service instances or tasks or jobs that were restarted on the stochastic computing resource 7 before completing on the stochastic computing resource 7. In this embodiment the reserved computing capacity of the deterministic resource 6 is jointly used for all the accepted contracts. There is no computing capacity on the deterministic resource 6 reserved for an individual contract. The total quantity of reserved resources is only sufficient at a probability P. If it is determined that the reserved computing capacity of the deterministic computing resource 6 is occupied by other contracts, it is not possible to transfer a remainder of a contract from the stochastic resource 7 to the deterministic resource 6. In this case, the contract conditions will be violated. However, the general controller unit 1 will maintain the required percentage P of contracts carried out observing the contract conditions. According to this procedure, it may happen that individual contracts cannot be fulfilled with the predetermined possibility, however, the sum of accepted contracts will assuredly be fulfilled with the predetermined probability P.

The required probability distribution of deterministic resources required to assure a given probability P is now calculated using the following method. Consider the example of a single contract for n slots where the quantiles of the distribution of slots lengths are guaranteed and assume that there is a relatively long period between the point at which the contract is offered to the service provider and the deadline for the contract to be finished T_{end}. Assume also that the distribution specified in the contract is the same as the distribution observed on the stochastic resource 7. First, the probability of needing more than a given quantity of deterministic resources 6 for the contract is worked out. The curve of probability versus resources is plotted. This curve can then be used to look up the required amount of resources needed to guarantee a given probability for the contract. This curve is given by equation 3 below.

Let R(k₁, . . . , k_{q}) be the quantity of deterministic resources 6 required to finish the rest of the contract given a random set of slots harvested from the stochastic resource 7. The contract specifies q quantiles each with n slots, so the total contract is for s=nq slots. In a random set of slots that were provided by the stochastic computing resource 7, kᵢ slots can be observed in each of the q quantiles where it goes from 1 to q. Additionally lᵢ is the (average) length of a slot in the quantile I such that:

$$R ( {k}_{1} , … , {k}_{q} ) = {\sum }_{j = 1}^{j = q} max ( n - {k}_{j} ) {l}_{j} \qquad ( 1 )$$

The probability of observing (k₁,. . . , k_{q}) is P( ) and is given by

$$P ( {k}_{1} , … , {k}_{q} ) = \frac{s !}{{q}^{s} {\prod }_{j = 1}^{j = q} ( {k}_{j} ! )} \qquad ( 2 )$$

So the probability of needing more than X deterministic resources to finish the contract, P{R>X} is

$$P \{ R > X \} = {\sum }_{( {k}_{1} , … , {k}_{q} ) s . t . \sum {k}_{i} = s} P ( {k}_{1} , … , {k}_{q} ) I ( R ( {k}_{1} , … , {k}_{q} ) > X ) \qquad ( 3 )$$

Where I( ) is an indicator function that evaluates to one if the condition contained in the brackets is true and otherwise to zero.

When the system has many contracts in play at the same time, slots are allocated to contracts randomly. This preserves the underlying distribution of slot lengths as far as each individual contract is concerned. In this case it is assumed that the slot length distribution is stationary.

When the deadline for the contract to be finished is close it is not desirable to use these analytic expressions but instead, run a simulation of the stochastic resource 7 under the slot allocation policy given in the preceeding paragraph hereinabove. This provides one estimate of the required amount of deterministic resources 6 required. Thus, a similar but Monte Carlo based estimator as equation 3 can be built, but based on simulation, equation 4 below, as follows where it is assumed that m simulations are run:
P{R>X}=(number of simulations requiring>X deterministic resources)/m (4)

This is of course typically slower than the analytic expression in equation 3 but has the advantage of full generality. This also works for cases where the contract has an arbitrary specification in terms of, say, the distribution of slot lengths and these may be different from the underlying distribution on the stochastic resource.

This is of course typically slower than the analytic expression in equation 3 but has the advantage of full generality. This also works for cases where the contract has an arbitrary specification in terms of, say, the distribution of slot lengths and these may be different from the underlying distribution on the stochastic resource.

In order to calculate the resources required for a group of contracts, rather than the single contract case described, to guaranteed completion with probability P the individual contract requirements are grouped together and considered as if there was just a single contract. This single contract will of course have more extensive requirements and specification than the underlying contracts from which it is constructed but the methods presented herein can be applied in the same way. It is noted that slots are allocated to contracts randomly and that each contract has its own budget of allowed attempts to use slots. Each contract may also, as before, have additional policies that specify whether longer slots are permitted substitutes for shorter slots or not.

While the invention has been particularly shown and described with respect to illustrative and preformed embodiments thereof, it will be understood by those skilled in the art that the foregoing and other changes in form and details may be made therein without departing from the spirit and scope of the invention which should be limited only by the scope of the appended claims.

1. A method for providing a requested computing resource service according to terms of a contract, said contract describing conditions of the requested computing resource service, said method comprising:
a) providing a first computing resource for fulfilling the resource contract, said first computing resource capable of being controlled by a guarantor of said contract to provide a requested computing service;
b) providing a second computing resource capable of providing computing capacity according to a stochastic process, said second computing resource incapable of being controlled by the guarantor; and,
c) utilizing the second computing resource for fulfilling the contract and utilizing the first computing resource for guaranteeing the fulfillment of the resource contract if the resource contract is incapable of being fulfilled utilizing only the second computing resource, wherein said contract guarantor accepts the contract with a guarantee to provide the requested computing resource service with the given conditions.

2. The method according to claim 1, further comprising the step of: offering a contract for providing a computing service, said offered contract capable of being accepted if the contract is fulfilled utilizing the computing capacity of the first computing resource.

3. The method according to claim 1, whereby the guarantor accepts the contract and guarantees the fulfillment of the contract with a determined possibility, said method further comprising the step of: reserving a respective computing capacity on the first computing resource according to the guaranteed probability for the fulfillment of the contract.

4. The method according to claim 3, further comprising: calculating the respective computing capacity as a probability distribution of a computing capacity, whereby a percentile of the probability distribution of the computing capacity of the first computing resource is reserved for guaranteeing the fulfillment of the contract.

5. The method according to claim 1, further comprising the steps of:
monitoring conditions of said second computing resources during fulfilling a contract, and comparing the conditions with the provided computing capacity; and,
detecting a probability of failing contract fulfillment; and,
transferring a remainder of said contract that is not yet fulfilled to the first computing resource if the probability of failing exceeds a given level.

6. The method according to claim 5, further comprising the step of: determining a time tolerance that defines a time before a time limit for fulfilling the contract, said step of monitoring conditions including monitoring the fulfilling of the contract before the time tolerance, and if the contract is not fulfilled before the time tolerance then utilizing the first computing resource for fulfilling the contract.

7. The method according to claim 3, whereby the reserved computing capacity of the first computing resource is used jointly for several accepted contracts, whereby the total quantity of the reserved computing capacity is sufficient for the accepted contracts with a given probability.

8. The method according to claim 1, wherein the second computing resource provides computing capacity for the guarantor during idle states of its own native tasks.

9. The method according to claim 1, further comprising the step of: determining a computing capacity of the second computing resource that the second computing resource could provide on average, and considering as available computing capacity for fulfilling the contract said average second computing resource computing capacity in combination with the computing capacity of the first computing resource.

10. The method according to claim 1, further comprising the step of: calculating the required quantity of the capacity of the first computing resource for fulfilling the contract by using quantile data of the available computing capacity of the stochastic resource relative to the requirements of the contract.

11. The method according to claim 10, whereby the required quantity of a capacity (R) of the first computing resource is calculated according to the following equation:
$$R ( {k}_{1} , … , {k}_{q} ) = {\sum }_{j = 1}^{j = q} max ( n - {k}_{j} ) {l}_{j} ,$$
whereby R (k₁, . . . , k_{q}) is the required quantity of the capacity of the first computing resource;
whereby kᵢ is the number of slots in the quantile;
whereby n is the number of slots requested by the contract in each quantile;
whereby lⱼ is the average length of a slot in the j^{th} quantile.

12. The method according to claim 10, whereby the probability (P) of needing more than a predetermined quantity (X) of a computing resource is calculated according to the following equation:
$$P \{ R > X \} = {\sum }_{( {k}_{1} , … , {k}_{q} ) s . t . \sum {k}_{i} = s} P ( {k}_{1} , … , {k}_{q} ) I ( R ( {k}_{1} , … , {k}_{q} ) > X )$$
whereby P{R>X} is the possibility of needing more than the quantity (X);
whereby P(k₁, . . . , k_{q}) is the probability of observing in a random set of s=n·q slots (k₁, . . . , k_{q}) in the q quantiles, whereby R(k₁, . . . , k_{q}) is the required quantity of the capacity of the first computing resource,
whereby I is an indicator function and X is the predetermined quantity of the first computing resource that is needed for finishing the contract.

13. A system for providing a requested computing resource service according to terms of a contract, said contract describing conditions of the requested computing resource service, said system comprising:
a first computing resource for fulfilling the resource contract, said first computing resource capable of being controlled by a guarantor of said contract to provide a requested computing service; and,
a second computing resource capable of providing computing capacity according to a stochastic process, said second computing resource incapable of being controlled by the by the guarantor; and,
a control means connected to said first and second computing resources for providing a requested computing resource service according to terms of a contract, said controller means utilizing the second computing resource for fulfilling the contract and utilizing the first computing resource for guaranteeing the fulfillment of the resource contract if the resource contract is incapable of being fulfilled utilizing only the second computing resource.

14. The system for providing a requested computing resource according to claim 13, further comprising an interface device connected to said control means for receiving a contract and enabling a contract guarantor to accept a contract with a guarantee to provide the requested computing resource service according to given conditions.

15. The system for providing a requested computing resource according to claim 13, wherein said control means comprises:
means for determining a computing capacity that may be guaranteed by said first deterministic computing resource; and,
means for calculating statistical probabilities for providing computing capacity by the second stochastic computing resources.

16. The system for providing a requested computing resource according to claim 15, further comprising: means for monitoring conditions of said first and second computing resources during fulfilling a contract, and comparing the conditions with the provided computing capacity,
means for detecting a probability of failing contract fulfillment; and,
means for transferring a remainder of said contract that is not yet fulfilled to the first computing resource if the probability of failing exceeds a given level.

17. The system for providing a requested computing resource according to claim 13, further comprising: a handling means connecting the control means with the second computing resource, said handling means having the ability to stop work it has started on the stochastic resource.

18. The system for providing a requested computing resource according to claim 14, wherein said second computing resource comprises a computer capacity harvesting system within a grid of computers that harvest free computing capacities of the computers and provide the diverted computing capacity to the control means.

19. A program storage device readable by a machine, tangibly embodying a program of instructions executable by the machine to perform method steps for providing a requested computing resource service according to terms of a contract, said contract describing conditions of the requested computing resource service, said method steps including the steps of:
a) providing a first computing resource for fulfilling the resource contract, said first computing resource capable of being controlled by a guarantor of said contract to provide a requested computing service;
b) providing a second computing resource capable of providing computing capacity according to a stochastic process, said second computing resource incapable of being controlled by the guarantor; and,
c) utilizing the second computing resource for fulfilling the contract and utilizing the first computing resource for guaranteeing the fulfillment of the resource contract if the resource contract is incapable of being fulfilled utilizing only the second computing resource, wherein said contract guarantor accepts the contract with a guarantee to provide the requested computing resource service with the given conditions.

20. The program storage device readable by a machine, tangibly embodying a program of instructions executable by the machine according to claim 19, wherein the method steps further comprise the step of: offering a contract for providing a computing service, said offered contract capable of being accepted if the contract is fulfilled utilizing the computing capacity of the first computing resource.

21. The program storage device readable by a machine, tangibly embodying a program of instructions executable by the machine according to claim 19, whereby the guarantor accepts the contract and guarantees the fulfillment of the contract with a determined possibility, said method steps further comprising the step of: reserving a respective computing capacity on the first computing resource according to the guaranteed probability for the fulfillment of the contract.

22. The program storage device readable by a machine, tangibly embodying a program of instructions executable by the machine according to claim 21, wherein the method steps further comprise the step of: calculating the respective computing capacity as a probability distribution of a computing capacity, whereby a percentile of the probability distribution of the computing capacity of the first computing resource is reserved for guaranteeing the fulfillment of the contract.

23. The program storage device readable by a machine, tangibly embodying a program of instructions executable by the machine according to claim 19, wherein the method steps further comprise the steps of:
monitoring conditions of said second computing resources during fulfilling a contract, and comparing the conditions with the provided computing capacity; and,
detecting a probability of failing contract fulfillment; and,
transferring a remainder of said contract that is not yet fulfilled to the first computing resource if the probability of failing exceeds a given level.

24. The program storage device readable by a machine, tangibly embodying a program of instructions executable by the machine according to claim 23, wherein the method steps further comprise the steps of: determining a time tolerance that defines a time before a time limit for fulfilling the contract, said step of monitoring conditions including monitoring the fulfilling of the contract before the time tolerance, and if the contract is not fulfilled before the time tolerance then utilizing the first computing resource for fulfilling the contract.

25. The program storage device readable by a machine, tangibly embodying a program of instructions executable by the machine according to claim 21, wherein the reserved computing capacity of the first computing resource is used jointly for several accepted contracts, whereby the total quantity of the reserved computing capacity is sufficient for the accepted contracts with a given probability.

26. The program storage device readable by a machine, tangibly embodying a program of instructions executable by the machine according to claim 19, wherein the method steps further comprise the step of: determining a computing capacity of the second computing resource that the second computing resource could provide on average, and considering as available computing capacity for fulfilling the contract said average second computing resource computing capacity in combination with the computing capacity of the first computing resource.

27. The program storage device readable by a machine, tangibly embodying a program of instructions executable by the machine according to claim 19, wherein the method steps further comprise the step of: calculating the required quantity of the capacity of the first computing resource for fulfilling the contract by using quantile data of the available computing capacity of the stochastic resource relative to the requirements of the contract.

28. The program storage device readable by a machine, tangibly embodying a program of instructions executable by the machine according to claim 27, whereby the required quantity of a capacity (R) of the first computing resource is calculated according to the following equation:
$$R ( {k}_{1} , … , {k}_{q} ) = {\sum }_{j = 1}^{j = q} max ( n - {k}_{j} ) {l}_{j} ,$$
whereby R (k₁, . . . , k_{q}) is the required quantity of the capacity of the first computing resource;
whereby kᵢ is the number of slots in the quantile;
whereby n is the number of slots requested by the contract in each quantile;
whereby lⱼ is the average length of a slot in the j^{th} quantile.

29. The program storage device readable by a machine, tangibly embodying a program of instructions executable by the machine according to claim 28, whereby the probability (P) of needing more than a predetermined quantity (X) of a computing resource is calculated according to the following equation:
$$P \{ R > X \} = {\sum }_{( {k}_{1} , … , {k}_{q} ) s . t . \sum {k}_{i} = s} P ( {k}_{1} , … , {k}_{q} ) I ( R ( {k}_{1} , … , {k}_{q} ) > X )$$
whereby P{R>X} is the possibility of needing more than the quantity (X);
whereby P(k₁, . . . , k_{q}) is the probability of observing in a random set of s=n·q slots (k₁, . . . , k_{q}) in the q quantiles, whereby R(k₁, . . . , k_{q}) is the required quantity of the capacity of the first computing resource,
whereby I is an indicator function and X is the predetermined quantity of the first computing resource that is needed for finishing the contract.
